(19) United States
(12) Patent Application Publication
(10) Pub. No.: US 2012/0302433 A1
(43) Pub. Date: Nov. 29, 2012

(54) Catalytic Reactor Treatment Process

(75) Inventors: Robert Peat, Longcot (GB); Neil Maxted, Humberside (GB)

(73) Assignee: COMPACTGTL PLC, Redcar, Cleveland (GB)

(21) Appl. No.: 13/575,117

(22) PCT Filed: Jan. 24, 2011
(86) PCT No.: PCT/GB2011/050105

§ 371 Date: Jul. 25, 2012

(30) Foreign Application Priority Data
Jan. 25, 2010 (GB) 1001144.3

(51) Int. Cl. B01J 37/16; B01J 37/18

(52) U.S. Cl. 502/100

(57) ABSTRACT

An activation process for a Fischer-Tropsch catalyst is described. The process comprises a first reduction step; an oxidation step; the introduction of the catalyst into a Fischer-Tropsch reactor; and a second reduction step.

This invention relates to a process for the treatment of a catalytic reactor prior to operation. It is applicable, particularly but not exclusively, to catalytic reactors for which the reactants comprise hydrogen and carbon monoxide (synthesis gas or syngas), for example Fischer-Tropsch synthesis and methanol synthesis. It relates to a shut-in process for such a reactor, and also to a process for in situ regeneration of the catalyst in such a reactor.

The Fischer-Tropsch synthesis process is a well-known process in which synthesis gas reacts in the presence of a suitable catalyst to produce hydrocarbons. This may form the second stage of a process for converting natural gas to a liquid or solid hydrocarbon, as natural gas can be reacted with either steam or small quantities of oxygen to produce the synthesis gas. A range of different types of reactor are known for performing the Fischer-Tropsch synthesis; and a range of different catalysts are suitable for Fischer-Tropsch synthesis. For example cobalt, iron and nickel are known catalysts, with different characteristics as to the resulting product.

Prior to first use in a Fischer-Tropsh reactor, a Fischer-Tropsch catalyst must be activated. As described in U.S. Pat. No. 4,729,981, a Fischer-Tropsch catalyst may be activated using a three step process comprising two reduction steps, between which an oxidation step is interposed. It has been suggested, for example in WO 02/083817, that activation of the catalyst can take place in situ provided that the maximum temperature does not exceed the standard operating temperature of the Fischer-Tropsch reactor. The three reactions that make up the activation process are all exothermic and, if activation can be achieved within a temperature regimen enabling it to take place in situ, then the activation can take advantage of the presence of heat exchange systems designed to cool the Fischer-Tropsch synthesis reaction.

However, in some environments in which Fischer-Tropsch reactors are used, especially off-shore, the use of oxidizing gases may present a safety issue and therefore activation of the catalyst in situ may not be possible.

During operation it may occasionally be necessary to cease operation of a catalytic reactor, and this may be referred to as a shut-in process. This may be a scheduled shutdown, or may be unscheduled. For example this may be necessary in a modular plant, where the number of reactors that are in use is changed in accordance with the flow rate of the gas to be treated. The shut-in process involves introducing gases into the reactor such that the catalytic reaction stops, without damaging the catalysts. By way of example hydrogen has been used as a shut-in gas, as have gases that are inert such as nitrogen and argon. It has been found that problems can arise when operation of the reactor is subsequently restarted.

Whichever metal is used as the catalyst, the selectivity and activity of the catalyst will typically deteriorate over time during operation of a synthesis reactor. It is therefore desirable to be able to regenerate the catalyst periodically. This may be performed by reducing the catalyst by exposure to a stream of hydrogen, and the reduction process usually happens at a higher temperature than the Fischer-Tropsch synthesis. By way of example U.S. Pat. No. 5,844,005 (Bauman et al/Exxon) describe a process for rejuvenating a deactivated hydrocarbon synthesis catalyst; the patent highlights that in the prior art the rejuvenating gas comprises hydrogen and should not contain CO, as any CO present would react with hydrogen in presence of the catalyst, which would be a waste of hydrogen. In Bauman's process the rejuvenating gas is a tail gas from the synthesis reaction and should contain less than 10 mole % CO, with a ratio of hydrogen to CO>3. U.S. Pat. No. 7,001,928 (Raje/Conoco Philips) describes a process for regenerating Fischer-Tropsch catalyst in the form of a slurry, using the reducing gas such as hydrogen or a hydrogen-rich gas, provided with a small amount of carbon monoxide at a concentration preferably no more than 5000 ppm, and at a temperature between 250 and 400° C.

According to the present invention there is provided a process for treatment of a catalytic reactor prior to operation with a reactant gas stream comprising hydrogen, which comprises contacting the catalyst with a treatment gas comprising at least one reducing agent, wherein the treatment gas comprises carbon monoxide, and the ratio of carbon monoxide to hydrogen in the treatment gas is greater than that in the reactant gas stream.

For example in the case of a Fischer-Tropsch catalytic reactor for operation with a reactant gas stream comprising synthesis gas with a ratio of hydrogen to carbon monoxide in the range 2.6 to 1.9 (corresponding to a carbon monoxide proportion between 27.8% and 34.5%) the treatment gas would preferably comprise at least 40% CO, more preferably at least 60%, still more preferably at least 80% CO, as a proportion of the reactive gases. Indeed the treatment gas might consist entirely of carbon monoxide. Alternatively the treatment gas may comprise an inert gas such as argon or nitrogen in combination with reactive gas, for example a 10% CO/90% nitrogen mixture.

The treatment may constitute shutting-in of the reactor, whether scheduled or unscheduled, so as to suppress the catalytic reaction. The reactor would subsequently be brought back on stream by restarting the supply of the reactant gas stream. The process of the present invention has been found to reduce the risk of thermal runaway when the catalytic reaction is restarted.

Alternatively the treatment may comprise regeneration of the catalyst of the catalytic reactor. Where regeneration is required, it may be performed at an elevated temperature, for example at above 250° C., for example at above 350° C., depending on the catalyst concerned; but an elevated pressure is not required. For example the treatment might be applied to a Fischer-Tropsch reactor, regenerating at less than 0.5 MPa, preferably at about 100 kPa (1 bar); and the Fischer-Tropsch reactor can subsequently be brought back on line. When performing regeneration it remains advantageous to use a higher ratio of carbon monoxide to hydrogen than in the reactant gas stream, but a treatment gas that contains up to 50% of hydrogen, as a proportion of the reactive gases, is more suitable for regeneration than for performing the shut-in operation.

The treatment gas may for example comprise a tail gas from a Fischer-Tropsch synthesis reaction that, if necessary, has been treated to remove at least some of the hydrogen. It will be appreciated that such a tail gas also contains other components, such as carbon dioxide, ethane and methane, but these are inert under these conditions.

The regeneration process brings about the reduction of the catalyst material, for example converting cobalt oxide to cobalt metal. It will be appreciated that a reduction process is also carried out during the initial production of the catalyst material, prior to its initial use in the reactor. This initial reduction process can also be carried out in accordance with the present invention, by performing the steps described above as regeneration. Indeed if this initial reduction process involves a succession of reduction steps, between which the catalyst is oxidised, then each reduction process, or at least the final reduction process, may be carried out in accordance with the present invention, by performing the steps described above as regeneration.

The process of the present invention may be advantageously applied to a reactor for Fischer-Tropsch synthesis and the Fischer-Tropsch catalyst may comprise active catalytic material in a ceramic support material forming a layer on a metal substrate, the metal substrate being shaped so as to subdivide a flow channel into a multiplicity of parallel flow sub-channels.

The process of the present invention may also be incorporated into a process of operating a catalytic reactor for Fischer-Tropsch synthesis. Following the treatment of the reactor in accordance with the process of the present invention, the Fischer-Tropsch reactor may be started up and during an initial operating period, the reactor may be provided with a synthesis gas with a lowered proportion of hydrogen; and then after the initial operating period the proportion of hydrogen in the synthesis gas may be increased to a steady-state value.

Furthermore, according to the present invention there is a provided an activation process for a Fischer-Tropsch catalyst, the process comprising: a first reduction step; an oxidation step; the introduction of the catalyst into a Fischer-Tropsch reactor; and a second reduction step.

The process may be carried out prior to operation of the Fischer-Tropsch reactor with a reactant gas stream. In this case, the second reduction step may be carried out using a reducing gas comprising carbon monoxide, wherein the ratio of carbon monoxide to hydrogen in the reducing gas is greater than that in the reactant gas stream.

More generally, the second reduction step may be carried out using a reducing gas comprising synthesis gas, natural gas, methanol or ammonia. Alternatively, the second reduction step may be carried out using a reducing gas comprising hydrogen-rich tail gas from a Fischer-Tropsch synthesis reaction. Before using it to perform the second reduction step, the tail gas may be processed to remove at least some of the hydrogen.

The first reduction step and the oxidation step may be carried out on the catalyst in a powdered form.

The step of introducing the catalyst into the Fischer-Tropsch reactor may include the steps of coating the catalyst onto a substrate before inserting the substrate carrying the catalyst into the Fischer-Tropsch reactor. The supported catalyst may be transported to the reactor for insertion. In this way, the application of the catalyst to the support may take place at a location remote from the Fischer-Tropsch reactor and the reduced and oxidized catalyst, on the support may be transported to the Fischer-Tropsch reactor for insertion and subsequent activation by reduction. The substrate may be a metal substrate in the form of a foil, a wire mesh, a felt sheet or a pellet core.

Alternatively, the step of introducing the catalyst into the Fischer-Tropsch reactor may include suspending the catalyst powder in a wash coat and flowing the wash coat through the reactor so that the catalyst coats a proportion of the internal surfaces of the reactor.

The invention will now be further and more particularly described, by way of example only.

The present invention is particularly suitable for treatment of Fischer-Tropsch catalysts within compact catalytic reactors, which may be deployed in remote locations including off shore locations as part of a plant for processing stranded or associated gas. The use of certain oxidizing gases on off shore rigs can present safety issues and therefore completing an activation process entirely in situ may not be practical. Such reactors may also be deployed in remote on-shore locations where infrastructure is limited, or on a smaller scale, even in a domestic context.

In order to prepare the catalyst for transportation to the reactor location the catalyst is reduced and then oxidized, resulting in a stable catalyst that can be transported without the need for passivation, such as wax encapsulation.

Once the catalyst has been transported and installed in the reactor, it is reduced in situ. This reduction process includes heating the reactor to a temperature sufficient to reduce the catalyst. The temperature will depend on the reduction gas which may be hydrogen, carbon monoxide, syngas or another hydrogen rich gas. The extent of reduction of the catalyst is primarily linked to the temperature of the reduction, rather than the duration of the reduction operation. For example, it may be desired to obtain an extent of reduction in excess of 75% or even 85% and if the reducing gas is 5% v/v hydrogen, the temperature may be in the region of 350° C. to 380° C. or even higher. Holding the temperature for reduction at the selected value for around four hours will be sufficient to reduce the catalyst and to achieve an equilibrium extent of reduction.

The activity of the catalyst once reduced is related to the temperature at which the reduction takes place. If the temperature is too low, then the catalyst may be excessively active when the catalyst is first used for Fischer-Tropsch synthesis, and therefore reduction temperatures in excess of 360° C. are preferred. If the temperature is too high then the catalyst will have low activity. For this reason the reduction temperature should not exceed 450° C. and should preferably be kept below 410° C.

In the case where the reductant gas is syngas, the reduction of the catalyst preferably takes place at near ambient pressure in order to minimize the extent of Fischer-Tropsch synthesis taking place using the catalyst already reduced. As the activity of the catalyst increases through the reduction process, the reduction temperature will be reduced in order to moderate the Fischer-Tropsch reaction rate. The temperature for reduction is therefore a balance between the desired extent of reduction and a manageable rate of Fischer-Tropsch synthesis that occurs at that temperature.

The uniformity of activity of the catalyst once reduced, depends at least in part on the maintaining a uniform temperature along the length of the catalyst during the reduction of the catalyst. By reducing the catalyst in situ, the temperature of the catalyst can be controlled using the adjacent channels which are used for cooling when the reactor is in use. This ensures that the temperature is uniform along the catalyst as the adjacent cooling channels help to reduce temperature gradients that could otherwise develop along the length of the catalyst insert.

In an exemplary plant to which the process of the present invention may be applied, the plant includes more than one reactor, wherein each reactor consists of a stack of plates that define synthesis flow channels and coolant flow channels arranged alternately within stack. Within each reactor the first and second flow channels may be defined by grooves in plates arranged as a stack, or by spacing strips and plates in a stack, the stack then being bonded together. Alternatively the flow channels may be defined by thin metal sheets that are castellated and stacked alternately with flat sheets; the edges of the flow channels may be defined by sealing strips. The stack of plates forming the reactor is bonded together for example by diffusion bonding, brazing, or hot isostatic pressing.

To ensure the required good thermal contact between the synthesis reaction and the coolant stream both the first and the second flow channels may be between 10 mm and 2 mm high (in cross-section); and each channel may be of width between about 3 mm and 25 mm. By way of example the plates (in plan view) might be of width in the range 0.05 m up to 1 m, and of length in the range 0.2 m up to 2 m, and the flow channels are preferably of height between 1 mm and 20 mm. For example the plates might be 0.5 m wide and 0.8 m long; and they might define channels for example 7 mm high and 6 mm wide, or 3 mm high and 10 mm wide, or 10 mm high and 5 mm wide. Catalyst structures are inserted into the channels for the synthesis reaction, and can if necessary be removed for replacement, and do not provide strength to the reactor, so the reactor itself must be sufficiently strong to resist any pressure forces or thermal stresses during operation. There may, in some cases, be two or more catalyst structures within a channel, arranged end to end.

Preferably each such catalyst structure is shaped so as to subdivide the flow channel into a multiplicity of parallel flow sub-channels. Preferably each catalyst structure includes a coating of ceramic support material on the metal substrate, which provides a support for the catalyst. The ceramic support is preferably in the form of a coating on the metal substrate, for example a coating of thickness 100 μm on each surface of the metal. The metal substrate provides strength to the catalyst structure and enhances thermal transfer by conduction. Preferably the metal substrate is of a steel alloy that forms an adherent surface coating of aluminium oxide when heated, for example a ferritic steel alloy that incorporates aluminium (eg Fecralloy™), but other materials such as stainless-steel may also be suitable. The substrate may be a foil, a wire mesh or a felt sheet, which may be corrugated, dimpled or pleated; the preferred substrate is a thin metal foil for example of thickness less than 200 μm, which is corrugated to define the longitudinal sub-channels. The catalyst element may for example comprise a single shaped foil, for example a corrugated foil of thickness 50 μm; this is particularly appropriate if the narrowest dimension of the channel is less than about 3 mm, but is also applicable with larger channels. Alternatively, and particularly where the channel depth or width is greater than about 2 mm, the catalyst structure may comprise a plurality of such shaped foils separated by substantially flat foils. The active catalytic material would be incorporated in the ceramic coating.

Alternatively, the catalyst may be pelletised. The pellets may either be provided with a metal substrate or core with a ceramic support material, or they may be pressed powder pellets which do not have a metal substrate.

The invention may also be applied to a further exemplary plant, not illustrated in the accompanying drawings, which is a fluidized bed reactor. Typically, a fluidized bed will have a higher inventory of catalyst than the mini-channel reactor described above which compensates for a lower activity within the catalyst. The reduction using syngas is particularly appropriate for this type of reactor because the catalyst is capable of moving within the reactor during reduction. This results in a substantially homogenous activity throughout the catalyst, thereby avoiding the situation wherein the catalyst is partially activated and undergoing Fischer-Tropsch synthesis, whilst part of the catalyst is not yet reduced.

The initial reduction of the catalyst and subsequent oxidation can be performed prior to the catalyst being applied to the substrate. In this case, the catalyst is still in a powdered form when the reduction and oxidation take place and these steps take place as part of the manufacturing process for the catalyst, thereby avoiding the time consuming and labour intensive loading of supported catalysts into a furnace for reduction and oxidation. Furthermore, by reducing and oxidizing the catalyst before it is applied to the support, the properties of the support do not have to be taken into consideration when selecting the conditions for reduction and oxidation. The reduced and oxidized catalyst is stable and can be applied to an appropriate catalyst support and the supported catalyst can then be transported without further treatment to the reactor. This differs considerably from transporting an active catalyst which must be passivated, for example by encapsulating it in wax, before it can be safely transported.

In a plant where a number of reactor are provided in parallel, new catalyst may be provided during a complete shut down of the plant, such as during planned maintenance. Alternatively, only one of a plurality of reactors may be shut down at any one time in order to provide continual service from the plant as a whole. In this later instance, the introduction of pre-reduced and oxidized catalyst to the reactor ensures that there is no danger of cross contamination between an oxidizing stream and an active process stream.

The invention enables the catalyst structures within the channels for the synthesis reaction to be protected during shut-in of the reactor. It would also enable the catalyst structures to be regenerated in situ, that is to say without removing the catalyst structures from the channels. It will be appreciated that in this situation, both during the synthesis process and also during the regeneration process, the catalyst structures are in contact with the gas phase, although there may be a thin coating of waxy hydrocarbon liquid on the surface of the catalyst structures. Unlike the situation in a slurry reactor, the catalyst structures within the channels of such a reactor are not immersed in liquid.

The invention is of relevance to a chemical process for converting natural gas (primarily methane) to longer chain hydrocarbons. The first stage of this process is to produce synthesis gas, and preferably involves steam reforming, that is to say the reaction:

H₂O+CH₄→CO+3 H₂

This reaction is endothermic, and may be catalysed by a rhodium or platinum/rhodium catalyst in a first gas flow channel. The heat required to cause this reaction may be provided by combustion of a fuel gas such as methane, or another short-chain hydrocarbon (e.g. ethane, propane, butane), carbon monoxide, hydrogen, or a mixture of such gases, which is exothermic and may be catalysed by a palladium/platinum catalyst in an adjacent second gas flow channel. Alternatively the synthesis gas may be produced by a partial oxidation process or an autothermal process, which are well-known processes; these produce synthesis gases of slightly different compositions.

The synthesis gas mixture is then used to perform a Fischer-Tropsch synthesis to generate longer chain hydrocarbons, that is to say:

n CO+2n H₂→(CH₂)ₙ+n H₂O

which is an exothermic reaction, occurring at an elevated temperature, typically between 190° C. and 280° C., and an elevated pressure typically between 1.8 MPa and 2.8 MPa (absolute values), in the presence of a catalyst such as iron, cobalt or fused magnetite. The preferred catalyst for the Fischer-Tropsch synthesis comprises a coating of gamma-alumina of specific surface area 140-230 m²/g with about 10-40% cobalt (by weight compared to the alumina), and with a promoter such as ruthenium, platinum or gadolinium which is less than 10% the weight of the cobalt, and a basicity promoter such as lanthanum oxide. Other suitable ceramic support materials are titania, zirconia, or silica. The preferred reaction conditions are at a temperature of between 200° C. and 240° C., and a pressure in the range from 1.5 MPa up to 4.0 MPa, for example 2.1 MPa up to 2.7 MPa, for example 2.6 MPa.

The activity and selectivity of the catalyst depends upon the degree of dispersion of cobalt metal upon the support, the optimum level of cobalt dispersion being typically in the range 0.1 to 0.2, so that between 10% and 20% of the cobalt metal atoms present are at a surface. The larger the degree of dispersion, clearly the smaller must be the cobalt metal crystallite size, and this is typically in the range 5-15 nm. Cobalt particles of such a size provide a high level of catalytic activity, but may be oxidised in the presence of water vapour, and this leads to a dramatic reduction in their catalytic activity. The extent of this oxidation depends upon the proportions of hydrogen and water vapour adjacent to the catalyst particles, and also their temperature, higher temperatures and higher proportions of water vapour both increasing the extent of oxidation. It is understood that during the regeneration process, this oxidation of the small cobalt particles is reversed, and they are converted back to the metal.

It is important that the characteristics of the catalyst are not significantly altered during a shut-in. Although shut-in can be performed using a gas such as hydrogen, which ensures there is no risk of oxidation of the catalyst, it has been found that there is a potential for thermal runaway when the catalytic reaction is restarted. It is envisaged that this may occur because, if hydrogen is already present on the surface of the catalyst, then when the reaction restarts methane is produced in preference to longer-chain molecules. This methane production produces more heat than does the production of longer-chain molecules.

It has been found that by using a treatment gas for shut-in that is high in carbon monoxide, for example pure carbon monoxide or a mixture of nitrogen and carbon monoxide, these problems are avoided. By way of example such a mixture may contain between 10% and 90% CO, with nitrogen. When operation restarts, there is an increase in the production of longer-chain molecules, and the risk of thermal runaways is suppressed.

A plant for performing Fischer-Tropsch synthesis may comprise a number of Fischer-Tropsch synthesis reactors operated in parallel, each reactor being provided with cut-off valves so that it can be disconnected from the plant. A reactor that has been cut-off in this way would conventionally be flushed through with an inert gas to suppress further reactions. In accordance with the present invention, as described above, the reactor is instead flushed through with CO, or a gas mixture containing CO, and is shut-in in this state. It has been found that if the reactor is then brought back online there is a decrease in methane formation during the initial bedding-in stage before steady-state operation is achieved. This is a clear benefit from shutting in with CO.

Typically it is found that the productivity of the catalyst decreases over a period of time (typically over several months). Although the reactor may be returned to its initial state by replacing the catalyst, this would involve considerable down-time, as catalyst replacement would be difficult to perform on-site. It is therefore advantageous to regenerate the catalyst in situ after a period of operation. However, conventional regeneration gives rise to the problem that after the reactor has been regenerated it can only be brought back on line gradually.

If regeneration of the catalyst in this module is then required, this can be carried out by raising the reactor temperature for example to 350° C. while causing a treatment gas which is reducing gas mixture consisting largely or exclusively of carbon monoxide to flow along the catalyst-containing channels. In this case a preferred treatment gas would, for example, comprise 70% CO and 30% hydrogen, or 80% CO and 20% hydrogen (optionally with other non-reactive gases). The treatment gas is preferably arranged to flow continuously over the substrate, preferably with a space velocity of at least 3000/hr, more preferably about 4000/hr. This has the benefit of preventing the development of hot-spots, and also removing any water vapour (formed by the reduction process, if hydrogen is present), so suppressing the formation of aluminates and oxides and hydrothermal ageing of the support if the ceramic comprises alumina. The space velocity, in this specification, is defined as the volume flow rate of the gases supplied to a chamber containing the ceramic support (measured at STP), divided by the void volume of the chamber. The pressure is preferably 100 kPa.

The treatment gas may be tail gas from the Fischer-Tropsch synthesis reaction that has been treated, if necessary, to remove hydrogen. The hydrogen removal may be achieved using a membrane, or by pressure swing absorption. Hence, as intimated above, a gas composition may be obtained that comprises less than 40% hydrogen, and at least 60% CO, as proportions of the reactive components, and such a gas composition is suitable for use as the treatment gas in the regeneration process.

Previously-known catalyst regeneration processes have used hydrogen as the reducing agent. Although this is effective at regenerating the catalyst, when the catalyst is subsequently brought back on line it is found that methane is produced in preference to longer chain molecules, and there is a significant time delay (typically several days of operation) before steady-state operation is achieved, with the formation of longer chain molecules. This problem is avoided by using carbon monoxide as a reducing agent, in accordance with the present invention.

After regeneration of the Fischer-Tropsch catalyst, the reactor can then be brought back on line as desired. During the bed-in process the reactor is preferably provided with synthesis gas with a comparatively low proportion of hydrogen, for example with hydrogen:CO ratio of 1.5:1. This suppresses methane formation while hydrocarbon intermediates are gradually formed on the catalyst surface. After a bedding-in time of for example 200 hr operation, it can be assumed that the catalyst has reached its steady-state; and the synthesis gas composition can then be returned to a higher value (with a hydrogen:CO ratio between 1.8 and 3.0:1, for example 1.9:1) while retaining selectivity to longer chain hydrocarbons, because hydrocarbon intermediates are now covering the catalyst surface, and/or because the catalyst at this stage is coated with a thin layer of waxy hydrocarbons through which the hydrogen and the CO of the synthesis gas must diffuse in order to react, and which therefore moderates the reaction.

Although the process of the invention has been described above in relation to Fischer-Tropsch reactors, it will be appreciated that it would be equally applicable to a range of different reactors, such as methanol-forming reactors. It has been described in relation to reactors in which the catalyst is supported on a corrugated foil, but it is equally applicable to reactors where the catalyst is coated on to channel walls, and to fluidised pellet bed reactors.

1.-10. (canceled)

11. An activation process for a Fischer-Tropsch catalyst, the process comprising:
a first reduction step applied to the catalyst in powdered form;
then an oxidation step applied to the catalyst in powdered form;
then the introduction of the oxidized catalyst into a Fischer-Tropsch reactor either:
(a) by forming a coating on a substrate from the catalyst material in powdered form, and then inserting the coated substrate into the Fischer-Tropsch reactor; or
(b) by forming a coating on internal surfaces of the reactor from the catalyst material in powdered form, by suspending the catalyst powder as a wash coat, and flowing the wash coat through the reactor; and
then a second reduction step applied to the oxidized catalyst material in the coating within the Fischer-Tropsch reactor.

12. The process according to claim 11, wherein the process is carried out prior to operation of the Fischer-Tropsch reactor with a reactant gas stream and wherein the second reduction step is carried out using a reducing gas comprising carbon monoxide, and the ratio of carbon monoxide to hydrogen in the reducing gas is greater than that in the reactant gas stream.

13. The process according to claim 11, wherein the second reduction step is carried out using a reducing gas comprising synthesis gas, natural gas, methanol or ammonia.

14. The process according to claim 12, wherein the second reduction step is carried out using a reducing gas comprising synthesis gas, natural gas, methanol or ammonia.

15. The process according to claim 11, wherein the second reduction step is carried out using a reducing gas comprising hydrogen-rich tail gas from a Fischer-Tropsch synthesis reaction.

16. The process according to claim 12, wherein the second reduction step is carried out using a reducing gas comprising hydrogen-rich tail gas from a Fischer-Tropsch synthesis reaction.

17. The process according to claim 15, wherein the tail gas is processed to remove at least some of the hydrogen, before using it to perform the second reduction step.

18. The process according to claim 16, wherein the tail gas is processed to remove at least some of the hydrogen, before using it to perform the second reduction step.

19. The process according to claim 11, wherein the first reduction step and the oxidation step are carried out on the catalyst in a powdered form.

20. The process according to claim 12, wherein the first reduction step and the oxidation step are carried out on the catalyst in a powdered form.

21. The process according to claim 13, wherein the first reduction step and the oxidation step are carried out on the catalyst in a powdered form.

22. The process according to claim 15, wherein the first reduction step and the oxidation step are carried out on the catalyst in a powdered form.

23. The process according to claim 17, wherein the first reduction step and the oxidation step are carried out on the catalyst in a powdered form.

24. The process according to claim 11, wherein the step of introducing the catalyst into the Fischer-Tropsch reactor includes the step of coating the catalyst onto a substrate, and the substrate is a metal substrate in the form of a foil, a wire mesh, a felt sheet or a pellet core.

25. The process according to claim 12, wherein the step of introducing the catalyst into the Fischer-Tropsch reactor includes the step of coating the catalyst onto a substrate, and the substrate is a metal substrate in the form of a foil, a wire mesh, a felt sheet or a pellet core.

26. The process according to claim 13, wherein the step of introducing the catalyst into the Fischer-Tropsch reactor includes the step of coating the catalyst onto a substrate, and the substrate is a metal substrate in the form of a foil, a wire mesh, a felt sheet or a pellet core.

27. The process according to claim 15, wherein the step of introducing the catalyst into the Fischer-Tropsch reactor includes the step of coating the catalyst onto a substrate, and the substrate is a metal substrate in the form of a foil, a wire mesh, a felt sheet or a pellet core.

28. The process according to claim 17, wherein the step of introducing the catalyst into the Fischer-Tropsch reactor includes the step of coating the catalyst onto a substrate, and the substrate is a metal substrate in the form of a foil, a wire mesh, a felt sheet or a pellet core.

29. The process according to claim 19, wherein the step of introducing the catalyst into the Fischer-Tropsch reactor includes the step of coating the catalyst onto a substrate, and the substrate is a metal substrate in the form of a foil, a wire mesh, a felt sheet or a pellet core.
